(19) United States
(12) Patent Application Publication
(10) Pub. No.: US 2009/0125393 A1
(43) Pub. Date: May 14, 2009

(54) System and method for utilizing account tiers in an electronic network

(75) Inventors: Paul Hwang, Burbank, CA (US); Frank Li-De Lin, San Diego, CA (US); Nikolaos Georgis, San Diego, CA (US)

Correspondence Address: Gregory J. Koerner;Redwood Patent Law, 1291 East Hillsdale Boulevard, Suite 205, Foster City, CA, 94404, US

(73) Assignees: Sony Corporation; Sony Electronics Inc.

(21) Appl. No.: 11/983,826

(22) Filed: Nov. 13, 2007

(51) Int. Cl. G06Q 30/00; G06Q 20/00

(52) U.S. Cl. 705/14; 705/39; 705/400

(57) ABSTRACT

A system and method for utilizing account tiers in an electronic network includes a peer-to-peer network of client devices. The client devices are configured to perform content transfers for obtaining desired content items directly over the peer-to-peer network, or from a CDN server device. The client devices generate account-tier selections to choose from among the supported account tiers. A tier manager monitors, updates, and stores the tier selections from the client devices. The tier manager also calculates content prices that vary depending upon the particular selected account tier. The client devices then pay the appropriate designated content prices for accessing and utilizing desired content items.

### BACKGROUND SECTION

1. Field of the Invention

This invention relates generally to techniques for managing electronic information, and relates more particularly to a system and method for utilizing account tiers in an electronic network.

2. Description of the Background Art

Implementing effective methods for managing electronic information is a significant consideration for designers and manufacturers of contemporary electronic devices. However, effectively managing information utilized by devices in an electronic network may create substantial challenges for system designers. For example, enhanced demands for increased device functionality and performance may require more system processing power and require additional software resources. An increase in processing or software requirements may also result in a corresponding detrimental economic impact due to increased production costs and operational inefficiencies.

Furthermore, enhanced device capability to perform various advanced data management operations may provide additional benefits to a system user, but may also place increased demands on the control and management of various system components. For example, an enhanced electronic network device that effectively manages electronic content information may benefit from an effective implementation because of the large amount and complexity of the digital data involved.

Due to growing demands on system resources and substantially increasing data magnitudes, it is apparent that developing new techniques for managing information in electronic networks is a matter of concern for related electronic technologies. Therefore, for all the foregoing reasons, developing effective techniques for managing information in electronic networks remains a significant consideration for designers, manufacturers, and users of contemporary electronic devices.

### SUMMARY

In accordance with the present invention, a system and method for utilizing account tiers in an electronic network are disclosed. In one embodiment, a network provider initially implements an electronic network that includes a CDN server, a tracking server, and a peer-to-peer network of client devices. A device user of a corresponding client device may then make a tier selection by utilizing any effective techniques. In certain embodiments, the device user may select either a CDN-P2P tier or a CDN-only tier.

The CDN-P2P tier typically supports transferring content items through either the CDN server or through other client devices in the peer-to-peer network. Conversely, the CDN-only tier does not support transfers with other client devices in the peer-to-peer network. The tracking server monitors, updates, and stores tier selections from the various client devices. At some point, a given client device may generate a content request for one or more specific content items. In response, the tracking server accesses a content catalogue of the supported content items, and also accesses the current tier selections of the client devices.

The tracking server calculates one or more content prices for requested content items from the content catalogue based upon the particular tier selection of the requesting client device. In certain embodiments, client devices in the CDN-only tier are CDN-only content prices that are typically higher than the CDN-P2P content prices that are charged to client devices in the CDN-P2P tier. The tracking server then sends the content catalogue and the one or more calculated content prices to the requesting client device. Finally, the client device may download and pay for the one or more requested content items. For at least the foregoing reasons, the present invention therefore provides an improved system and method for utilizing account tiers in an electronic network.

### BRIEF DESCRIPTION OF THE DRAWINGS

FIG. 1A is a block diagram of an electronic network, in accordance with one embodiment of the present invention;

FIG. 1B is a block diagram of the peer-to-peer network of FIG. 1A, in accordance with one embodiment of the present invention;

FIG. 2 is a block diagram for one embodiment of the tracking server of FIG. 1, in accordance with the present invention;

FIG. 3 is a block diagram for one embodiment of the server memory of FIG. 2, in accordance with the present invention;

FIG. 4 is a diagram illustrating a segmented content preloading procedure, in accordance with one embodiment of the present invention;

FIG. 5 is a block diagram for one embodiment of a client device from FIG. 1A, in accordance with the present invention;

FIG. 6 is a block diagram for one embodiment of the device memory of FIG. 5, in accordance with the present invention;

FIG. 7 is a block diagram for one embodiment of the tier selections from FIG. 3, in accordance with the present invention;

FIG. 8 is a block diagram for one embodiment of the content prices from FIG. 3, in accordance with the present invention;

FIGS. 9A, 9B, and 9C are a flowchart of method steps for performing a tier selection procedure, in accordance with one embodiment of the present invention; and

FIG. 10 is a flowchart of method steps for performing a content pricing procedure, in accordance with one embodiment of the present invention.

### DETAILED DESCRIPTION

The present invention relates to an improvement in electronic information management techniques. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Therefore, the present invention is not intended to be limited to the embodiments shown, but is to be accorded the widest scope consistent with the principles and features described herein.

The present invention comprises a system and method for utilizing account tiers in an electronic network, and includes a peer-to-peer network of client devices. The client devices are configured to perform content transfers for obtaining desired content items directly over the peer-to-peer network, or from a CDN server device. The client devices generate account-tier selections to choose from among the supported account tiers. A tier manager monitors, updates, and stores the tier selections from the client devices. The tier manager also calculates content prices that vary depending upon the particular selected account tier. The client devices then pay the appropriate designated content prices for accessing and utilizing desired content items.

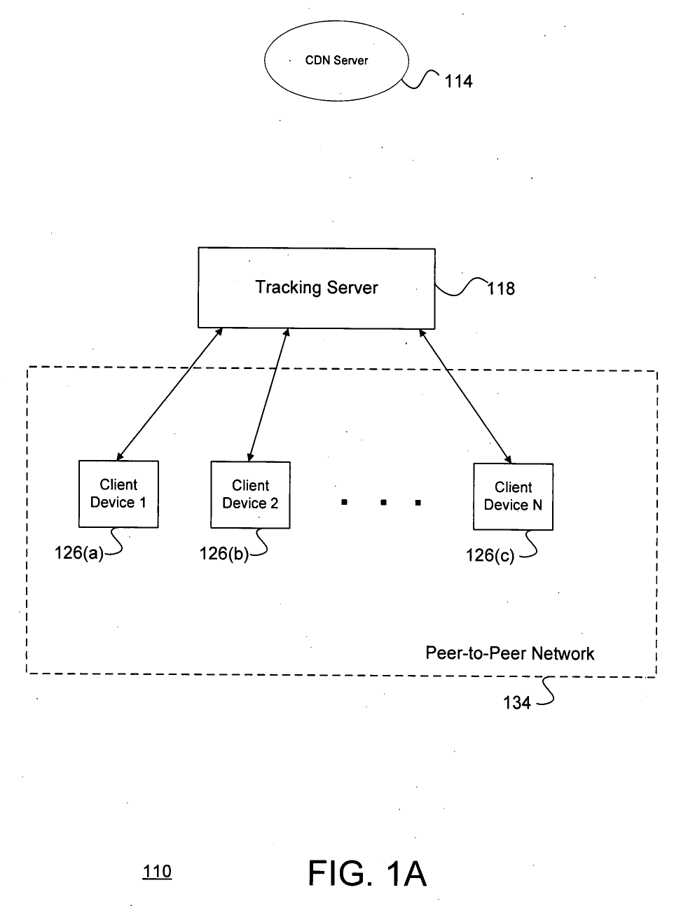

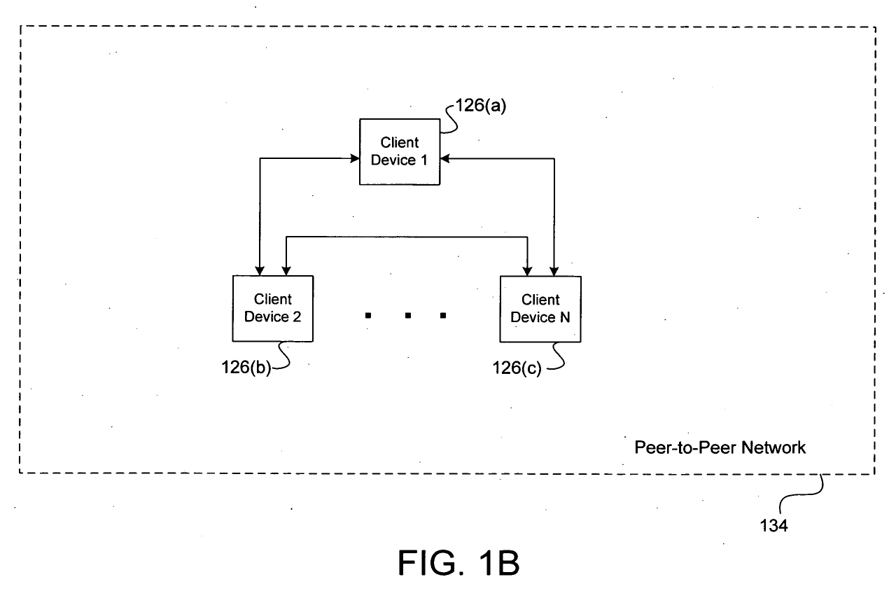

Referring now to FIG. 1A, a block diagram of an electronic network 110 is shown, in accordance with one embodiment of the present invention. In the FIG. 1A embodiment, electronic network 110 may include, but is not limited to, a content distribution network (CDN) server 114, a tracking server 118, and a plurality of client devices 126. In alternate embodiments, electronic network 110 may be implemented by utilizing components and configurations in addition to, or instead of, certain of those components and configurations discussed in conjunction with the FIG. 1A embodiment.

In accordance with the present invention, any desired number of client devices 126 may be configured in a peer-to-peer network 134 that is further discussed below in conjunction with FIG. 1B. In the FIG. 1A embodiment, client devices 126 may include an electronic device 1 (126(a)) through an electronic device N 126(c). In the FIG. 1A embodiment, each of the client devices 126 may bi-directionally communicate directly with other ones of the client devices 126 by utilizing any appropriate peer-to-peer communication techniques or other effective communication methods.

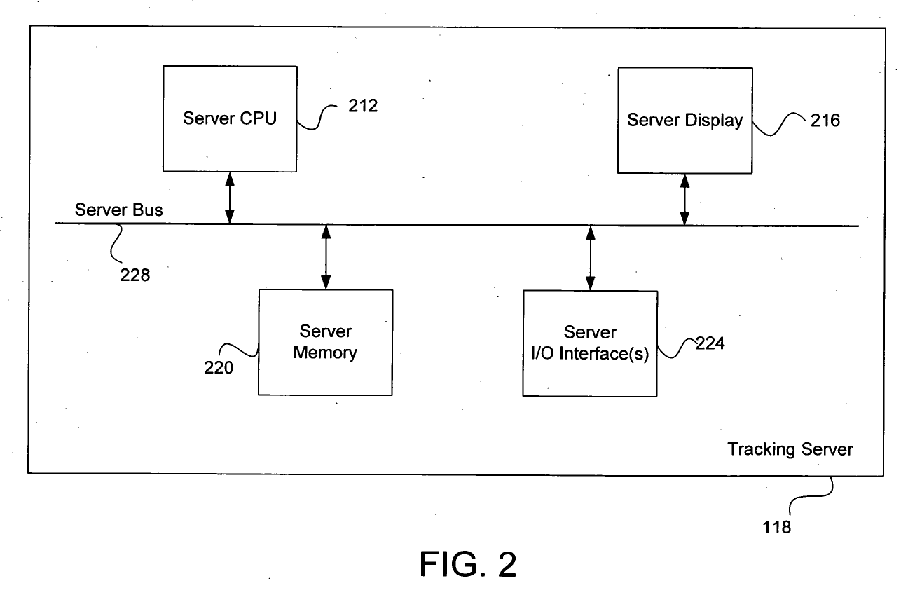

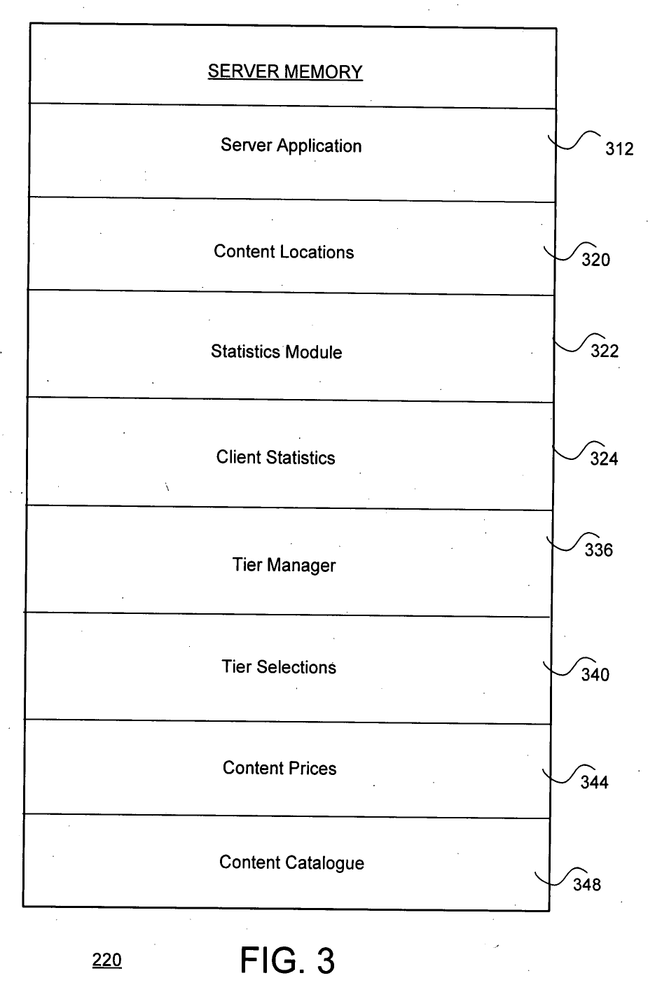

In accordance with the present invention, some or all of the client devices 126 may be advantageously preloaded with various pre-determined content items. The content items may include any desired types of electronic information. For example, content items may include, but are not limited to, entertainment programming, movies, video data, audio data, digital photographs, still image data, graphics, web pages, program guide information, and various types of software programs, etc. System users may thus perform appropriate content transfer procedures through peer-to-peer network 134 to access and utilize desired content items. In the FIG. 1A embodiment, tracking server 118 may be implemented in any effective manner to track the current locations of the various content items. One implementation for tracking server 118 is further discussed below in conjunction with FIGS. 2-3.

In the FIG. 1A embodiment, CDN server 114 may be implemented as any appropriate entity for providing any desired type of content data or other information. For example, in certain embodiments, CDN server 114 may be operated by a content management entity that produces or obtains the content data from any number of different content sources. In certain embodiments, a network provider entity (not shown) may implement and support tracking server 118 and some or all of the client devices 126 in peer-to-peer network 134. In the FIG. 1A embodiment, client devices 126 typically pay content usage fees to the network provider in return for viewing or otherwise utilizing transferred content items from any source. The network provider typically pays the CDN server 114 a relatively high CDN download fee for any transferred content items that are downloaded from CDN server 114. For example, in certain embodiments, the CDN download fee may be proportional to the size of the downloaded content items.

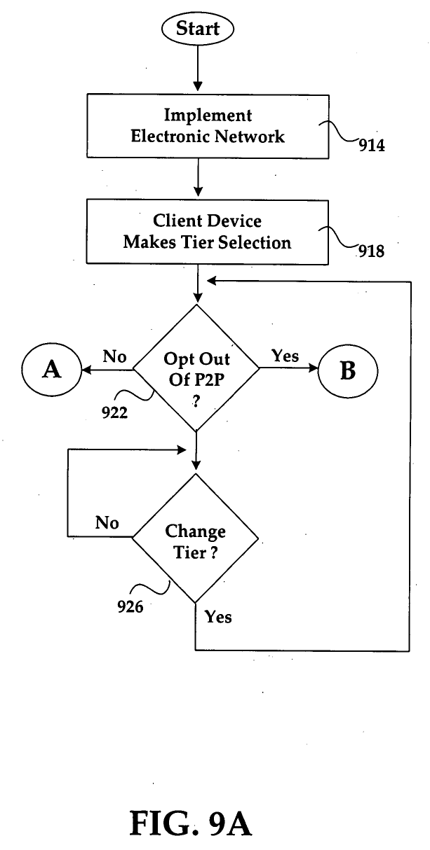

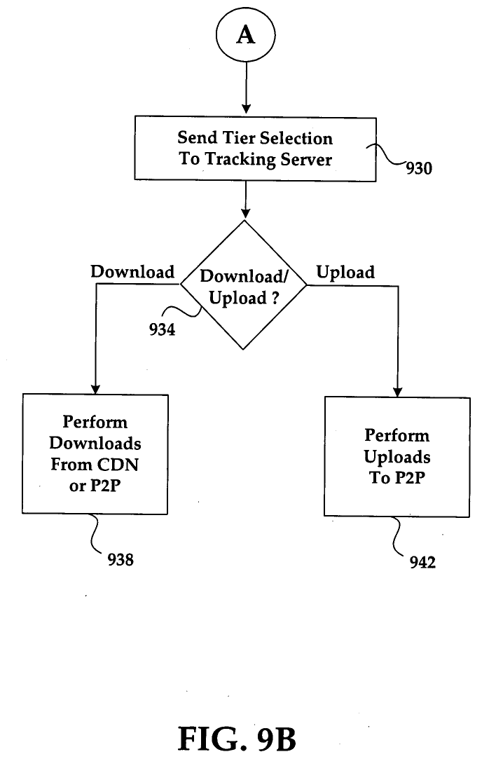

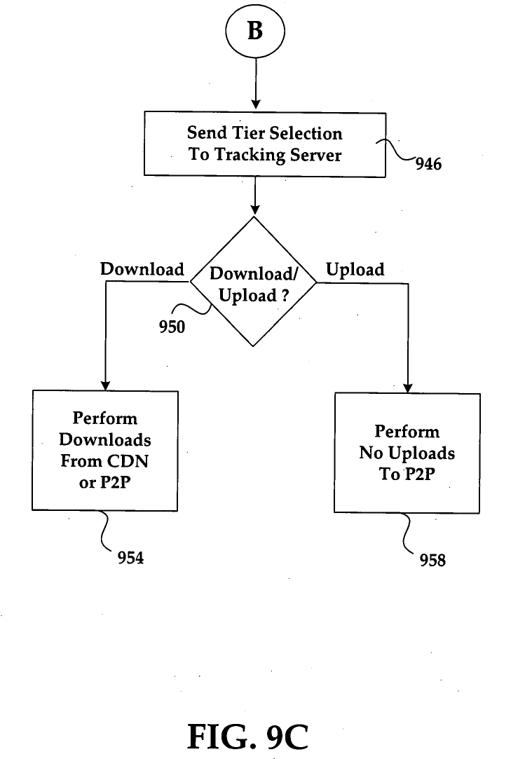

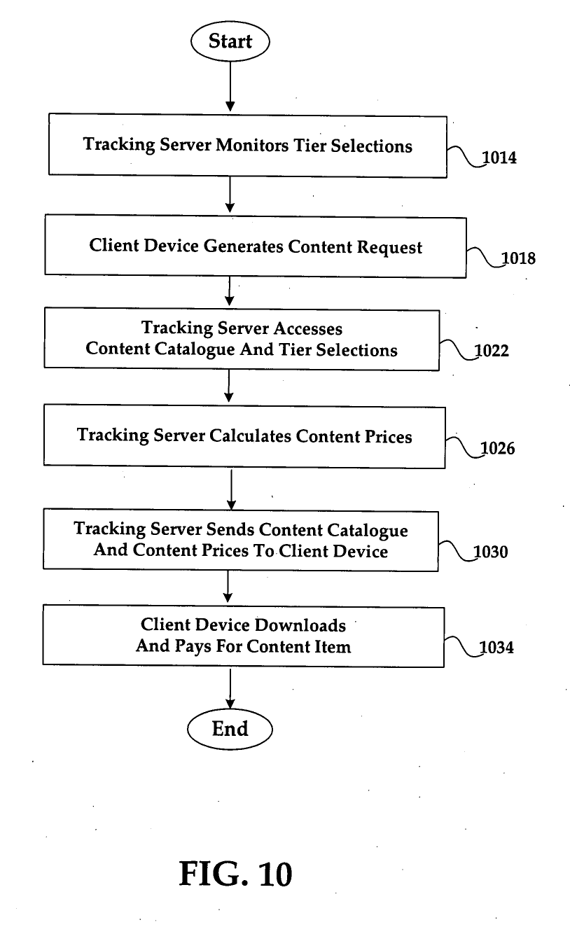

However, in the case of peer-to-peer transfer procedures, there is no CDN download fee for receiving content items from other client devices 126. Peer-to-peer transfer procedures thus provide a more economical leveraging technique for disseminating content items to the various client devices 126. In accordance with the present invention, the network provider may advantageously utilize account tiers for the client devices 126 to encourage peer-to-peer downloads instead of CDN downloads. More specifically, client devices 126 that affirmatively opt out of utilizing peer-to-peer transfers may be placed into a CDN-only tier that is charged higher content prices that include a surcharge for downloading content items from CDN server 114. Charging client devices 126 according to their respective tier selection advantageously permits the network provider to recover the cost of the CDN download fees for CDN-only clients. Additional details regarding techniques for utilizing account tiers are further discussed below in conjunction with FIGS. 9-10.

Referring now to FIG. 1B, a block diagram of the FIG. 1A peer-to-peer network 134 is shown, in accordance with one embodiment of the present invention. The FIG. 1B embodiment includes a client device 1 (126(a)), a client device 2 (126(b)), through a client device N (126(a)). In alternate embodiments, peer-to-peer network 134 may be implemented by utilizing components and configurations in addition to, or instead of, certain of those components and configurations discussed in conjunction with the FIG. 1B embodiment. Furthermore, peer-to-peer network 134 may be implemented to include any desired number of client devices 126.

In the FIG. 1B embodiment, each of the client devices 126 may bi-directionally communicate directly with any other of the client devices 126 by utilizing any desired peer-to-peer communication techniques or other effective communication methods. For example, client device 1 (126(a)) may bi-directionally communicate directly with either client device 2 (126(b)) or client device N (126(c)). Similarly, client device 2 (126(b) may bi-directionally communicate directly with client device N (126(c)). Furthermore, in the FIG. 1B embodiment, any of the client devices 126 in peer-to-peer network 134 may perform a peer-to-peer content transfer procedure to transfer content items to any of the other client devices 126 in peer-to-peer network 134. Additional details regarding the utilization of the FIG. 1B peer-to-peer network 134 are further discussed below in conjunction with FIGS. 9-10.

Referring now to FIG. 2, a block diagram for one embodiment of the FIG. 1A tracking server 118 is shown, in accordance with the present invention. In the FIG. 2 embodiment, tracking server 118 includes, but is not limited to, a server central processing unit (server CPU) 212, a server display 216, a server memory 220, and one or more server input/output interface(s) (server I/O interface(s)) 224. The foregoing components of tracking server 118 may be coupled to, and communicate through, a server bus 228. In alternate embodiments, tracking server 118 may alternately be implemented using components and configurations in addition to, or instead of, certain of those components and configurations discussed in conjunction with the FIG. 2 embodiment.

In the FIG. 2 embodiment, server CPU 212 may be implemented to include any appropriate and compatible microprocessor device that preferably executes software instructions to thereby control and manage the operation of tracking server 118. The FIG. 2 server display 216 may include any effective type of display technology including a cathode-ray-tube monitor or a liquid-crystal display device with an appropriate screen for displaying various information to a server user. In the FIG. 2 embodiment, server memory 220 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of server memory 220 are further discussed below in conjunction with FIG. 3.

In the FIG. 2 embodiment, server I/O interface(s) 224 may include one or more input and/or output interfaces to receive and/or transmit any required types of information by tracking server 118. Server I/O interface(s) 224 may include one or more means for allowing a server user to communicate with tracking server 118. The utilization of tracking server 118 is further discussed below in conjunction with FIGS. 9-10.

Referring now to FIG. 3, a block diagram for one embodiment of the FIG. 2 server memory 220 is shown, in accordance with the present invention. In the FIG. 3 embodiment, server memory 220 may include, but is not limited to, a server application 312, contents locations 320, statistics module 322, client statistics 324, a tier manager 336, tier selections 340, content prices 344, and a content catalogue. In alternate embodiments, server memory 220 may include various other components and functionalities in addition to, or instead of, certain those components and functionalities discussed in conjunction with the FIG. 3 embodiment.

In the FIG. 3 embodiment, server application 312 may include program instructions that are preferably executed by server CPU 212 (FIG. 2) to perform various functions and operations for tracking server 118. The particular nature and functionality of server application 312 typically varies depending upon factors such as the specific type and particular functionality of the corresponding tracking server 118. For example, in the FIG. 3 embodiment, server application 312 may monitor any transfers of content items between the various client devices 126.

Server application 312 may then dynamically update content locations 320 to incorporate any new changes in the current storage locations of the various content items on client devices 126. Content locations 320 may include, but are not limited to; the original factory preload locations of the various content items. In certain embodiments, content locations 320 may include unique content item identifiers that are associated with corresponding client device identifiers that represent the respective client devices 126 on which the content items are stored.

In the FIG. 3 embodiment, statistics module 322 may monitor and compile client statistics 324 that reflect any appropriate information and characteristics of peer-to-peer network 134 (FIG. 2). For example, client statistics 324 may include any desired type of statistical information regarding content transfer procedures for transferring content items directly between client devices 126 in peer-to-peer network 134. In certain embodiments, statistics module 322 may periodically query client devices 126 to obtain updated client statistics 324.

Alternately, client devices 126 may automatically inform statistics module 322 regarding any new content transfer procedures, and statistics module 322 may then update client statistics 324. In the FIG. 3 embodiment, client statistics 324 may be collected for each client device 126, and may include, but are not limited to, upload transfer throughput statistics, download transfer statistics, peer-to-peer transfer frequency, transferred content types, transfer target devices, transfer source devices, transferred content titles, and any other relevant statistical transfer patterns or information.

In the FIG. 3 embodiment, tier manager 336 may monitor tier selections 340 from client devices 126 to generate corresponding content prices 344 that are based upon the respective tier selections 340. Content catalogue 348 may include, but is not limited to, a list of specific content items that are supported by electronic network 110. Additional details regarding the utilization of tier selections 340 are further discussed below in conjunction with FIGS. 9-10.

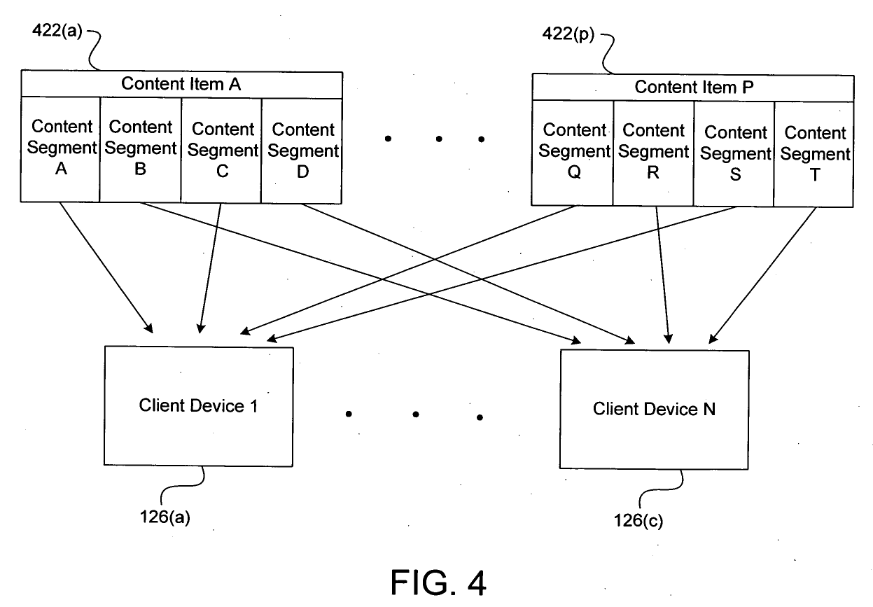

Referring now to FIG. 4, a diagram illustrating a segmented content preloading procedure is shown, in accordance with one embodiment of the present invention. The FIG. 4 example is presented for purposes of illustration, and in alternate embodiments, the present invention may perform segmented or non-segmented content preloading procedures by utilizing techniques and configurations in addition to, or instead of, certain of those techniques and configurations discussed in conjunction with the FIG. 4 embodiment.

In certain situations, manufacturers of various electronic devices may desire to preload content items 422 onto their electronic devices, and offer some of these content items without cost, so that the system users may be more likely to begin using their services. One limitation of pre-loading entire content items is the physical size of device hard disks, as well as the manufacturing time needed to image the hard disk in the factory. For example, if a manufacturer wishes to preload two high-definition movies onto an electronic device, then the required size of the hard disk to store the movies might be over 200 Gigabytes, and imaging the hard disks would be very time-consuming.

Another problem is that the manufacturer must very carefully choose which content items to pre-load. Because of the large amount of digital data involved, the limited number of content items would likely not satisfy all customers, but might be attractive only to a limited subset of system users. In addition, there are various significant security issues with pre-loaded content items, because customers may be able to extract the content items without any authorization. In certain environments, manufacturers may offer their content items by means of downloading. However, this downloading option is very expensive because of the high download fees charged by content providers.

In accordance with the FIG. 4 embodiment, instead of preloading entire content items, the present invention proposes that content items 422 be divided into any desired number of different content segments of any appropriate segment size(s). In the FIG. 4 embodiment, for purposes of illustration, the shown content items 422 are both divided into four content segments. Any desired number of different content items 422 may be utilized. In the FIG. 4 example, content item A 422(a) is divided into four content segments A through D, and content item P 422(p) is divided into four content segments Q through T. However, the number of different content segments and their corresponding segment sizes is not fixed. Also, all content items 422 need not have the same number or size of content segments. The number and size of content segments per content item 422 may be determined in any effective and optimal manner.

Segmented content preloading procedures may then performed by optimally selecting and storing a subset of content segments from the various content items 422 onto individual client devices 126. In accordance with the present invention, any desired number of client devices 126 may be utilized. All client devices 126 need not receive content segments. However, each content segment from every content item 422 is preferably preloaded onto at least one client device 126. The content segments may be mapped to corresponding client devices 126 in any effective manner. For example, in the FIG. 4 embodiment, client device 1 (126(a)) receives content segments A and C from content item A 422(a) and content segments Q and S from content item P 422(p). Similarly, client device N 126(c) receives content segments B and D from content item A 422(a) and content segments R and T from content item P 422(p). System users may then browse a complete content catalog of available content items 422 to initiate peer-to-peer transfers for obtaining required content segments for the content items 422 of their choice.

In accordance with the foregoing segmented content preloading procedure, storage capacity (hard disk size) of the client devices 126 does not pose a serious limitation because only a relatively small content segment from every content item 422 is pre-loaded. High-definition content (with greater amounts of image data) may thus be more effectively supported. In addition, the preloaded content may now be personalized to individual user tastes because system users may flexibly select from an extensive content catalogue of contents items, instead of just a few content items that were preloaded in their entirety. With regard to content security issues, the preloaded content segments can not be used to assemble complete content items 422 because initially there are many content segments that are missing from any given client device 126.

In addition, a complete set of content segments from the content items 422 is preloaded in a distributed manner to the various client devices 126. There is therefore no need for downloading content from content providers, and thus no expensive download fees. Furthermore, as new content items become available, corresponding new content segments may be preloaded onto new client devices 126 for subsequent dissemination to other client devices 126 through peer-to-peer network 134.

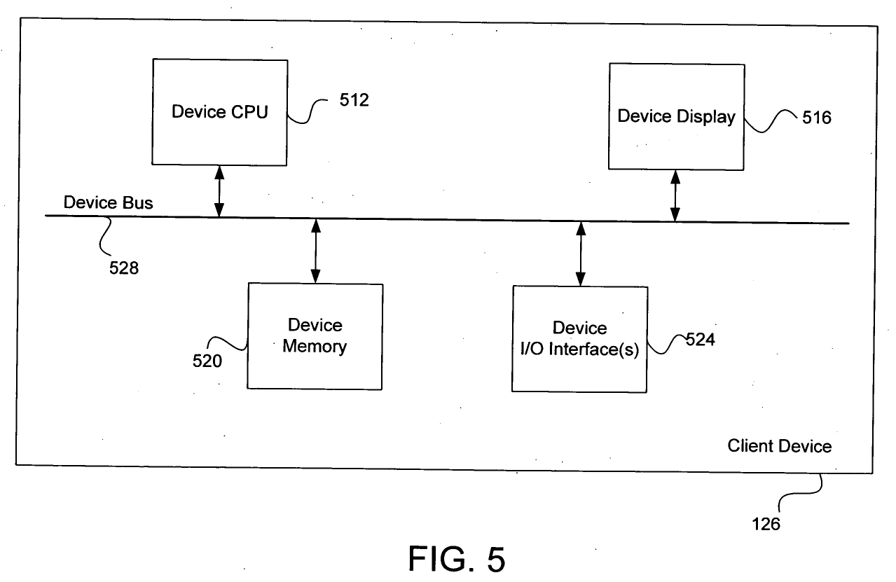

Referring now to FIG. 5, a block diagram for one embodiment of a FIG. 1A client device 126 is shown, in accordance with the present invention. In the FIG. 5 embodiment, client device 126 may include, but is not limited to, a device central processing unit (device CPU) 512, a device display 516, a device memory 520, and one or more device input/output interface(s) (device I/O interface(s)) 524. The foregoing components of client device 126 may be coupled to, and communicate through, a device bus 528.

In alternate embodiments, client device 126 may readily be implemented using various components and configurations in addition to, or instead of, certain of those components and configurations discussed in conjunction with the FIG. 5 embodiment. Furthermore, in the FIG. 5 embodiment, client device 126 may be implemented as any type of appropriate electronic device. For example, in certain embodiments, client device 126 may be implemented as any type of stationary or portable electronic device, such as a personal computer, a television, a consumer-electronics device, a cellular telephone, a settop box, an audio-visual entertainment device, or a personal digital assistant (PDA).

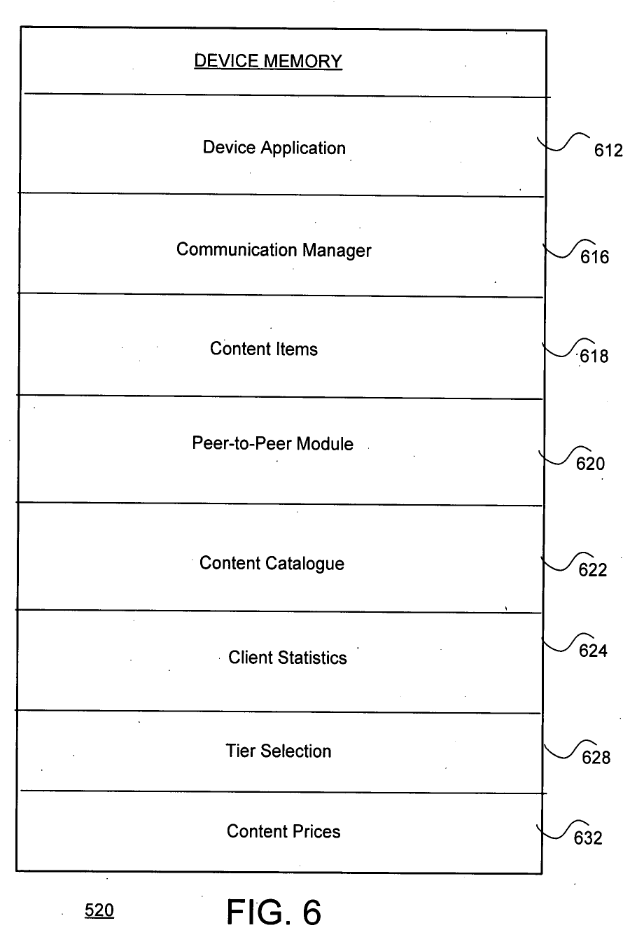

In the FIG. 5 embodiment, device CPU 512 may be implemented to include any appropriate and compatible microprocessor device that preferably executes software instructions to thereby control and manage the operation of client devices 126. The FIG. 5 device display 516 may include any effective type of display technology including a cathode-ray-tube monitor or a liquid-crystal display device with an appropriate screen for displaying various information to a device user. In the FIG. 5 embodiment, device memory 520 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of device memory 520 are further discussed below in conjunction with FIG. 6.

In the FIG. 5 embodiment, device I/O interface(s) 524 may include one or more input and/or output interfaces to receive and/or transmit any required types of information by client device 126. Device I/O interface(s) 524 may include one or more means for allowing a device user to communicate with other entities in electronic network 110 (FIG. 1A). For example, the foregoing means may include a keyboard device, a wireless remote-control device, a speech-recognition module with corresponding microphone, a graphical user interface with touch-screen capability, a hand-held device controller unit, or a selection button array mounted externally on client device 126. The implementation and utilization of client device 126 are further discussed below in conjunction with FIGS. 9-10.

Referring now to FIG. 6, a block diagram for one embodiment of the FIG. 5 device memory 520 is shown, in accordance with the present invention. In the FIG. 6 embodiment, device memory 520 includes, but is not limited to, a device application 612, a communications manager 616, content items 618, a peer-to-peer module 620, a content catalogue 622, client statistics 624, a tier selection 628, and content prices 632. In alternate embodiments, device memory 520 may include various other components and functionalities in addition to, or instead of, certain of those components and functionalities discussed in conjunction with the FIG. 6 embodiment.

In the FIG. 6 embodiment, device application 612 may include program instructions that are preferably executed by a device CPU 512 (FIG. 5) to perform various functions and operations for a client device 126. The particular nature and functionality of device application 612 typically varies depending upon factors such as the specific type and particular functionality of the corresponding client device 126.

In the FIG. 6 embodiment, communication manager 616 may perform communication procedures for exchanging electronic information with external entities by utilizing any appropriate techniques. For example, communication manager 616 may bi-directionally communicate with tracking server 118 or CDN server 114 to obtain current location information for specific required content segments 618. In the FIG. 6 embodiment, content items 618 may include either content items that were initially preloaded onto a client device 126 during manufacture, or content items that were subsequently received from other client devices 126 or CDN server 114.

In the FIG. 6 embodiment, peer-to-peer module 620 may be utilized by a particular client device 126 to directly communicate with any other client device 126 in peer-to-peer network 134 (FIG. 2). For example, peer-to-peer module 620 may perform a content item transfer procedure to either upload content items to, or download content items from, other client devices 126 in peer-to-peer network 134.

In the FIG. 6 embodiment, content catalogue 622 may include an extensive listing of all content items 422 that are available from client devices 126. In the FIG. 6 embodiment, client statistics 624 may include any relevant statistics or information regarding the operation of a host client device 126. In the FIG. 6 embodiment, tier selection 628 may include information that specifies the selected account tier for a given client device 126. In the FIG. 6 embodiment, content prices 632 may include specific content usage fees received from tracking server 118 depending upon the particular tier selection 628. The utilization and implementation of client device 126 is further discussed below in conjunction with FIGS. 9-10.

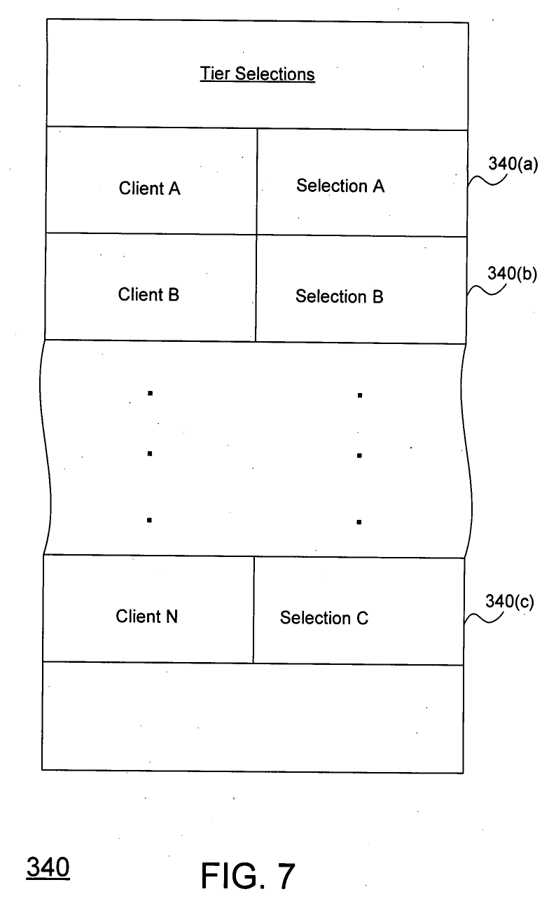

Referring now to FIG. 7, a block diagram for one embodiment of the FIG. 3 tier selections 340 is shown, in accordance with the present invention. The FIG. 7 embodiment is presented for purposes of illustration, and in alternate embodiments, tier selections 340 may include other components and information in addition to, or instead of, certain of those components and information discussed in conjunction with the FIG. 7 embodiment.

In the FIG. 7 embodiment, tier selections 340 include, but are not limited to, individual account tier selections corresponding respectively to client A 126(a) through client N 126(c). For example, in the FIG. 7embodiment, a client device A 126(a) has information corresponding to a tier selection A 340(a). In the FIG. 7 embodiment, tracking server 118 may analyze tier selections 340 and responsively generate corresponding respective content prices 344 (FIG. 3) by utilizing any effective techniques.

In certain embodiments, tier selections 340 may be chosen from any appropriate designated account tiers. For example, in the FIG. 7 embodiment, devices users of client devices 126 may perform a tier selection procedure to chose between either a CDN-only tier or a CDN/P2P tier. The CDN-only tier indicates that a given client device 126 would only obtain content items from CDN server 114, while a CDN/P2P tier indicates that a given client device 126 could obtain content items from either CDN server 114 or directly through peer-to-peer network 134. In certain embodiments, other account tiers are also contemplated. For example, a P2P-only tier may be supported for obtaining content items only through peer-to-peer network 134. Utilization of tier selections is further discussed below in conjunction with FIGS. 9-10.

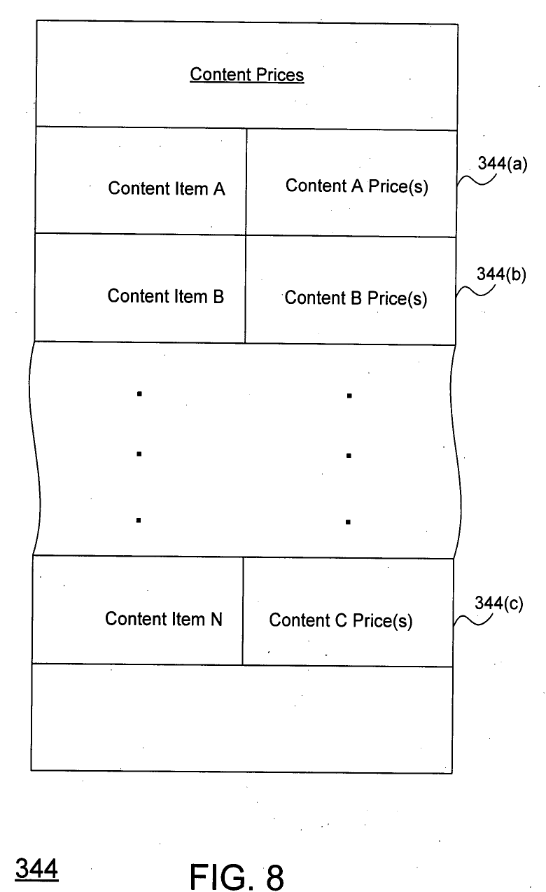

Referring now to FIG. 8, a block diagram for one embodiment of the FIG. 3 content prices 344 is shown, in accordance with the present invention. The FIG. 8 embodiment is presented for purposes of illustration, and in alternate embodiments, content prices 344 may include other components and information in addition to, or instead of, certain of those components and information discussed in conjunction with the FIG. 8 embodiment.

In the FIG. 8 embodiment, content prices 344 include, but are not limited to, one or more individual content prices (A through C) corresponding respectively to client A 126(a) through client N 126(c). For example, in the FIG. 8 embodiment, a client device A 126(a) has information corresponding to one or more content A prices 344(a). In the FIG. 8 embodiment, a tier manager 336 (FIG. 3) of tracking server 118 calculates the content prices 344 by referencing tier selections 340. In the FIG. 8 embodiment, content prices 344 may be determined by utilizing any effective methods.

For example, in certain embodiments, tier manager 336 may utilize a predefined lookup table to convert appropriate tier selections 340 into corresponding content prices 344. Alternately, tier manager 336 may utilize an updatable algorithm to calculate one or more content prices 344 based upon current incentive priorities, performance criteria, and CDN download fees in electronic network 110. In the FIG. 8 embodiment, the magnitude of the respective content prices 344 is preferably greater for clients in the CDN-only tier.

In certain embodiments, tier manager 336 may alter other performance characteristics in electronic network 110 based upon tier selections 340. These other performance characteristics may be chosen in addition to, or instead of, the differences in content prices 344 based upon the respective account tiers. For example, in certain embodiments, client devices 126 that do not opt out of content transfers via peer-to-peer network 134 may be accorded a higher transfer priority when downloading from CDN server 114 (for example, by allowing a higher transfer bandwidth, accessibility, or speed). Additional details for generation of content prices 344 are further discussed below in conjunction with FIG. 10.

Referring now to FIGS. 9A, 9B, and 9C, a flowchart of method steps for performing a tier selection procedure is shown, in accordance with one embodiment of the present invention. The flowchart of FIGS. 9A-9C is presented for purposes of illustration, and in alternate embodiments, the present invention may utilize steps and sequences other than those steps and sequences discussed in conjunction with FIGS. 9A-9C.

In the FIG. 9A embodiment, in step 914, a network provider initially implements an electronic network 110 that includes a CDN server 114, a tracking server 118, and a peer-to-peer network 134 of client devices 126. In step 918, a device user of a corresponding client device 126 makes a tier selection 628 by utilizing any effective techniques. In step 922, if the device user selects a CDN-P2P tier, then the FIG. 9A process advances to step 930 of FIG. 9B through connector “A.” Conversely, if the device user selects a CDN-only tier, then the FIG. 9A process advances to step 946 of FIG. 9C through connector “B.” In step 926, if the device user decides to change tier selection 628, then the FIG. 9A process returns to the foregoing step 922.

In step 930 of FIG. 9B, the client device 126 sends the current tier selection 628 to tracking server 118 for storage with other tier selections 340 from other client devices 126. In step 934, if client device 126 requires a download operation to receive a requested content item, then in step 938, client device 126 may perform downloads from either CDN server 114 or from other client devices 126 in peer-to-peer network 134. However, in step 934, if an upload operation is required to send a requested content item, then in step 942, client device 126 may perform uploads to other client devices 126 in peer-to-peer network 134.

In step 946 of FIG. 9C, the client device 126 sends the current tier selection 628 to tracking server 118 for storage with other tier selections 340 from other client devices 126. In step 950, if client device 126 requires a download operation to receive a requested content item, then in step 954, client device 126 may perform downloads from either CDN server 114 or from other client devices 126 in peer-to-peer network 134. However, in step 958, since client device 126 has previously selected the CDN-only tier, client device 126 may not perform uploads to other client devices 126 in peer-to-peer network 134. For at least the foregoing reasons, the present invention therefore provides an improved system and method for utilizing account tiers in an electronic network.

Referring now to FIG. 10, a flowchart of method steps for performing a content pricing procedure is shown, in accordance with one embodiment of the present invention. The flowchart of FIG. 10 is presented for purposes of illustration, and in alternate embodiments, the present invention may utilize steps and sequences other than those steps and sequences discussed in conjunction with the FIG. 10.

In the FIG. 10 embodiment, in step 1014, tracking server 118 monitors and updates tier selections 340 from the various client devices 126. In step 1018, a client device 126 generates a content request for one or more particular content items. In step 1022, tracking server 118 accesses content catalogue 348 and tier selections 340. In step 1026, tracking server 118 calculates content prices 344 for content items in content catalogue 348 based upon the particular tier selection 340 of the requesting client device 126. In step 1030, tracking server 118 sends content catalogue 348 and the calculated content prices 344 to the requesting client device 126. Finally, in step 1034, the client device 126 may download and pay for the one or more requested content items with the calculated content prices 344. For at least the foregoing reasons, the present invention therefore provides an improved system and method for utilizing account tiers in an electronic network.

The invention has been explained above with reference to certain embodiments. Other embodiments will be apparent to those skilled in the art in light of this disclosure. For example, the present invention may readily be implemented using certain configurations and techniques other than those described in the specific embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for utilizing account tiers in an electronic network, comprising:
client devices that are configured to perform content transfers of content items in said electronic network, said client devices generating tier selections to choose from among said account tiers; and
a tier manager that stores said tier selections from said client devices, said tier manager calculating content prices that vary depending upon said tier selections, said client devices paying said content prices for utilizing said content items.

2. The system of claim 1 wherein said tier manager resides on a tracking server that monitors content locations of said content items on said client devices, said client devices being configured in a peer-to-peer network that supports direct bi-directional communications between any of said client devices.

3. The system of claim 2 wherein said electronic network further includes a content delivery network server that stores certain of said content items for downloading to said client devices.

4. The system of claim 3 wherein said content items include entertainment programming, movies, video data, audio data, digital photographs, still image data, graphics, web pages, program guide information, and software programs.

5. The system of claim 3 wherein said account tiers include a CDN-only tier and a CDN-P2P tier, said CDN-only tier receiving said content items only from said content delivery network server, said CDN-P2P tier receiving said content items from either said content delivery network server or said client devices in said peer-to-peer network.

6. The system of claim 5 wherein said peer-to-peer network and said tracking server are implemented by a network provider that receives said content prices from said client devices for utilizing said content items.

7. The system of claim 6 wherein said content prices include a CDN-only price and a CDN-P2P price, said CDN-only price being paid by said CDN-only tier, said CDN-P2P price being paid by said CDN-P2P tier, said CDN-only price being greater than said CDN-P2P price.

8. The system of claim 7 wherein said content distribution network server charges a CDN download fee to said network provider for downloading said content items to said client devices.

9. The system of claim 8 wherein a CDN-only surcharge in said CDN-only price recovers said CDN download fee paid by said network provider to said content delivery network server.

10. The system of claim 8 wherein a CDN-only surcharge in said CDN-only price provides a financial incentive for said client devices to select said CND-P2P tier.

11. The system of claim 5 wherein said CDN-P2P tier receives a higher transfer priority than said CDN-only tier for transferring said content items.

12. The system of claim 7 wherein a client from among said client devices performs a tier selection procedure to choose a client tier from among said account tiers.

13. The system of claim 12 wherein said client chooses said CDN-P2P tier, said client reporting said client tier to said tier manager, said client then being able to perform downloads of said content items from either said content delivery network server or said peer-to-peer network, said client also being able to perform uploads of said content items to said peer-to-peer network.

14. The system of claim 12 wherein said client chooses said CDN-only tier, said client reporting said client tier to said tier manager, said client then being able to perform downloads of said content items from either said content delivery network server or said peer-to-peer network, said client being unable to perform uploads of said content items to said peer-to-peer network.

15. The system of claim 12 wherein said client generates a content request to obtain a selected content item from among said content items.

16. The system of claim 15 wherein said tier manager accesses a content catalogue of said content items, said tier manager also accessing said tier selections.

17. The system of claim 16 wherein said tier manager performs a content price calculation procedure to determine specific ones of said content prices depending upon said client tier that was chosen by said client during said tier selection procedure.

18. The system of claim 17 wherein said tier manager utilizes a content price lookup table to determine said specific ones of said content prices during said content price calculation procedure.

19. The system of claim 17 wherein said tier manager utilizes an updateable algorithm to calculate said specific ones of said content prices during said content price calculation procedure.

20. The system of claim 17 wherein said tier manager sends said content catalogue and said specific ones of said content prices to said client, said client responsively downloading and paying for said selected content item according to said specific ones of said content prices.

21. A method for utilizing account tiers in an electronic network, comprising:
performing content transfers of content items in said electronic network by utilizing client devices;
generating tier selections with said content devices to choose from among said account tiers;
storing said tier selections from said client devices with a tier manager; and
calculating content prices with that vary depending upon said tier selections, said client devices paying said content prices for utilizing said content items.

22. A system for utilizing account tiers in an electronic network, comprising:
means for performing content transfers of content items in said electronic network;
means for generating tier selections to choose from among said account tiers;
means for storing said tier selections;
means for calculating content prices with that vary depending upon said tier selections; and
means for paying said content prices for utilizing said content items.
